(19) United States
(12) Patent Application Publication
(10) Pub. No.: US 2008/0181247 A1
(43) Pub. Date: Jul. 31, 2008

(54) Method and apparatus for processing queue in network system

(75) Inventors: Jin-Ho Kim, Seoul (KR); Jin-Young Bae, Gyeonggi-do (KR); Chae-Yong Chong, Gyeonggi-do (KR); Sang-Young Lee, Seoul (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/011,325

(22) Filed: Jan. 25, 2008

(30) Foreign Application Priority Data
Jan. 25, 2007 (KR) 2007-0007789

(51) Int. Cl. H04L 12/56

(52) U.S. Cl. 370/412

(57) ABSTRACT

Queue processing method and apparatus in a network system are provided. The queue processing method in a network system includes when a packet is input to a buffer, checking whether the buffer belongs to the same memory channel; when the buffer does not belong to the same memory channel, converting an address of a buffer descriptor about the packet to an address of a next packet address storage of the same channel of a queue; and enqueuing the converted address.

### CROSS-REFERENCE TO RELATED APPLICATION(S) AND CLAIM OF PRIORITY

This application claims priority under 35 U.S.C. §119(a) to an application filed in the Korean Intellectual Property Office on Jan. 25, 2007 and assigned Serial No. 2007-7789, the disclosure of which is herein incorporated by reference.

### TECHNICAL FIELD OF THE INVENTION

The present invention relates generally to queue processing apparatus and method in a network system. More particularly, the present invention relates to an apparatus and a method for processing buffers using different channels at a single queue in a network device.

### BACKGROUND OF THE INVENTION

For a rapid queue processing, a high-speed network device has a queue array (Q_array) and queue commands (enqueue and dequeue) in a memory controller. The queue array is an array of queue descriptors. In conventional queue descriptors of FIG. 1A, the queue descriptor 100a includes a pointer (head) 102a for a first packet of the queue, a pointer (tail) 104a for a last packet of the queue, and a number of packets in the queue (Q_Count) 106a to manage the queue. The head 102 of the queue descriptor 100a contains an address A 108a of the first packet, the first packet contains an address B 110a of the next packet, the second packet contains an address C 112a of the third packet, and the third packet contains an address D 114a of the fourth item. The tail 104a of the queue descriptor 100a contains the address D of the last (the fourth) packet, and the Q-Count 106a is 4. That is, the four packets are linked as a linked list to form one queue.

FIG. 1B illustrates a conventional packet insertion (enqueue) to a buffer.

In the linked list of the four packets in FIG. 1A, when an enqueue command for a packet of an address Z 116b is fed to a memory controller, i.e., when a packet is inserted to the buffer, the memory controller changes the packet address D to the packet address Z in the tail 104b of the queue descriptor 100b and increases the Q_Count 106b by one as shown in FIG. 1B. Hence, with one packet added to the existing four packets, the Q_Count 106b becomes 5.

FIG. 1C illustrates a conventional packet removal (dequeue) from the buffer.

When a dequeue command is fed to a memory controller in FIG. 1B, i.e., when the packet is removed from the buffer, the memory controller returns the packet address A in the head 102c, changes to the packet address B, and decreases the Q_Count 106c by one as shown in FIG. 1C. Since one packet is removed from the existing five packets, the Q_Count 106c becomes 4.

The enqueue and the dequeue have been explained in view of the queue descriptor in FIG. 1. Now, a buffer descriptor for describing information of a buffer which stores packets is described. Herein, the buffer descriptor generally includes 8 LongWords (LWs) and one LW is 4 bytes in size. The buffer descriptor is used to represent packets stored into the buffer. The buffer descriptor can be represented as Table 1.

TABLE 1

| | | Size | |
|---|---|---|---|
| LW | Bits | [bits] | Variable Name |
| 0 | 31:0 | 32 | buffer_next |
| 1 | 31:16 | 16 | buffer_size |
| | 15:0 | 16 | offset |
| 2 | 31:16 | 16 | packet_size |
| | 15:12 | 4 | free_list_id |
| | 11:8 | 4 | rx_stat |
| | 7:0 | 8 | header_type |
| 3 | 31:16 | 16 | input_port |
| | 15:0 | 16 | output_port |
| 4 | 31:16 | 16 | next_hop_id |
| | 15:8 | 8 | fabric_port |
| | 7:4 | 4 | reserved |
| | 3:0 | 4 | nhid_type |
| 5 | 31:0 | 32 | flow_id |
| 6 | 31:16 | 16 | class_id |
| | 15:0 | 16 | reserved_2 |
| 7 | 31:0 | 32 | packet_next |

In Table 1, 0 LW is 32-bit (0˜31 bits) buffer_next address information, and 1 LW is 16-bit (16˜31 bits) buffer_size information and 16-bit (0˜15 bits) offset information. 2 LW is 16-bit (16˜31 bits) packet_size information, 4-bit (12˜15 bits) free_list_id information, 4-bit (8˜11 bits) rx_stat information, and 8-bit (0˜7 bits) header_type information. 3 LW is 16-bit (16˜31 bits) input_port information and 16-bit (0˜15 bits) output_port information. 4 LW is 16-bit (16˜31 bits) next_hop_id information, 8-bit (8˜15 bits) fabric_port information, 4-bit (4˜7 bits) reserved, and 4-bit (0˜3 bits) nhid_type information. 5 LW is 32-bit (0˜31 bits) flow_id information. 6 LW is 16-bit (16˜31 bits) class_id information and 16-bit (0˜15 bits) reserved_{—}2. 7 LW is 32-bit (0˜31 bits) packet_next address information.

FIG. 2A illustrates a relation between the conventional queue descriptor and the conventional buffer descriptor.

The queue descriptor 200a of FIG. 2A includes a head 202a, a tail 204a, and Q_Count 206a. The head 202a contains an address A+7 of storage of a packet address A, the tail 204a contains an address C+7 of storage of a packet address C, and the Q_Count 206a contains a value 3. Namely, the addresses A+7, B+7, and C+7 of the three packet address storages form one queue through the linked list; that is, the three packets constitute one queue in the buffer. The packets are represented using buffer descriptors 208a, 210a and 212a based on Table 1. Herein, the buffer descriptors 208a, 210a and 212a contain various information relating to the size and the type of the packets in the buffer, the input and output port numbers, the pointer to the next buffer of the same packet, and the pointer to the first buffer of the next packet. Each buffer descriptor 208a, 210a and 212a is 32 bytes in size and is divided into eight LWs (LW 0˜LW 7).

The buffer descriptor 208a for the first packet allocates a pointer storage area for managing the queue from the packet address A to the packet address A+7 (LW 7). The allocated storage area contains information of LW 0˜LW 7 of Table 1. Particularly, LW 7 contains the address B+7 of the next packet address storage. Likewise, the buffer descriptor 210a for the second packet allocates a pointer storage area for managing the queue B˜B+7. LW 7 of the buffer descriptor 210a contains the address C+7 of the next packet address storage. The buffer descriptor 212a for the third packet allocates a pointer storage area for managing the queue C˜C+7 to thus constitute the linked list. FIG. 2B illustrates only the queue related parts of FIG. 2A, like FIGS. 1A to 1C. Detailed descriptions of FIG. 2B shall be omitted.

FIG. 3 is a flowchart of a conventional packet insertion (enqueue) in the buffer.

In step 300, a network device acquires a start address of a buffer descriptor to be added. For example, when the packet of the address D is inserted to the buffer in FIG. 2A, the network device acquires the packet address D.

In step 302, the network device converts the packet address D to an address to constitute a linked list. For example, the network device converts the acquired packet address to the address D+7 of the packet address storage. This is because the address D+7 of the packet address storage, not the packet address D, is used in the linked list. Using the buffer descriptors in Table 1, the address conversion merely adds 7 to the address of the buffer descriptor because LW 7 includes the address information of the next packet address storage.

In step 304, the network device describes information of the corresponding buffer. For example, the network device includes the converted address D+7 to LW 7 of the previous last buffer descriptor 212a.

In step 306, the network device enqueues the corresponding address to the queue. For example, the network device changes the tail 204a of the corresponding queue descriptor from C+7 to D+7 and increases Q_Count 206a by one.

Next, the network device finishes this enqueue process.

FIG. 4 is a flowchart of a conventional packet removal (dequeue) from the buffer.

In step 400, the network device commences the dequeue. For example, when the packet is removed from the buffer in FIG. 2A, the network device changes the head 206a of the corresponding queue descriptor from A+7 to B+7 and decreases Q_Count 206a by one.

In step 402, the network device returns the address in the head of the queue descriptor. For example, the network device returns the head 206a, A+7, of the corresponding queue descriptor.

In step 404, the network device converts the address of the packet address storage to a packet address (a start address of the buffer descriptor). For example, the network device converts the address A+7 of the packet address storage to the packet address A (the start address of the buffer descriptor).

Next, the network device finishes the dequeue process.

Processing the packets, the network device is divided into software blocks for processing the incoming packets and software blocks for processing the outgoing packets. If the number of packets to be processed is quite small in a low speed, merely one memory channel can be used. In a high-speed mass system requiring a high memory capacity, two or more memory channels are used. However, the conventional queue management using the memory controller and the conventional buffer structure cannot control the buffer in the different channel because the memory controller is able to control the memory only in the same channel. Thus, one of the memory channels is allocated for the incoming packets and the other memory channel is used for the outgoing packets.

When the network device needs to send out the incoming packet or to return the outgoing packet to the internal system, the packet allocated to the buffer in one channel should be provided to the software block which processes the other channel. The conventional method allocates the packet to a new buffer in a different channel and then processes the packet, without directly providing the packet. However, since the packet duplication in the exception processing or the new buffer allocation results in the very low processing speed and the considerable load in view of the network device, it is not suitable for the system which processes the high-speed packets.

### SUMMARY OF THE INVENTION

To address the above-discussed deficiencies of the prior art, it is a primary object of the present invention to substantially solve at least the above problems and/or disadvantages and to provide at least the advantages below. Accordingly, an aspect of the present invention is to provide a method and an apparatus for processing a queue in a network system.

Another aspect of the present invention is to provide a method and an apparatus for processing buffers which use different channels at one queue in a network system.

Yet another aspect of the present invention is to provide a method and an apparatus for processing packets in one queue when incoming packets need to be sent out or when outgoing packets need to be returned to an internal system in a network system.

The above aspects are achieved by providing a queue processing method in a network system, which includes when a packet is input to a buffer, checking whether the buffer belongs to the same memory channel; when the buffer does not belong to the same memory channel, converting an address of a buffer descriptor about the packet to an address of a next packet address storage of the same channel of a queue; and enqueuing the converted address.

According to one aspect of the present invention, a queue processing method in a network system includes when a packet is output from a buffer, checking whether the buffer belongs to the same memory channel; when the buffer does not belong to the memory channel, converting an address of a next packet address storage of the same channel of a queue to an address of a buffer descriptor using channel information of the buffer; and dequeuing the converted address.

According to another aspect of the present invention, a queue processing apparatus in a network system includes a channel checker for, when a packet is input to a buffer, checking whether the buffer belongs to the same memory channel; an address converter for, when the buffer does not belong to the same memory channel, converting an address of a buffer descriptor about the packet to an address of a next packet address storage of the same channel of a queue; and a buffer manager for enqueuing the converted address.

According to yet another aspect of the present invention, a queue processing apparatus in a network system includes a channel checker for, when a packet is output from a buffer, checking whether the buffer belongs to the same memory channel; an address converter for, when the buffer does not belong to the memory channel, converting an address of a next packet address storage of the same channel of a queue to an address of a buffer descriptor using channel information of the buffer; and a buffer manager for dequeuing the converted address.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have, a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A is a diagram of a conventional queue descriptor;

FIG. 1B is a diagram of a conventional packet insertion (enqueue) to a buffer;

FIG. 1C is a diagram of a conventional packet removal (dequeue) from a buffer;

FIGS. 2A and 2B are diagrams of a relation between a conventional queue descriptor and a conventional buffer descriptor;

FIG. 3 is a flowchart of a conventional packet insertion (enqueue) to a buffer;

FIG. 4 is a flowchart of a conventional packet removal (dequeue) from a buffer;

FIG. 5 is a flowchart of a packet insertion (enqueue) to a buffer according to an embodiment of the present invention;

FIG. 6 is a flowchart of a packet removal (dequeue) from the buffer according to an embodiment of the present invention;

FIG. 7 is a diagram of a queue storage in the buffer structure of Table 2 according to an embodiment of the present invention;

FIG. 8 is a flowchart of a packet insertion (enqueue) in the buffer structure of Table 2 according to an embodiment of the present invention;

FIG. 9 is a flowchart of a packet removal (dequeue) in the buffer structure of Table 2 according to an embodiment of the present invention;

FIG. 10 is a diagram of a buffer structure according to another embodiment of the present invention;

FIG. 11 is a diagram of a queue storage in the buffer structure of FIG. 10 according to an embodiment of the present invention;

FIG. 12 is a flowchart of a packet insertion (enqueue) in the buffer structure of FIG. 10 according to an embodiment of the present invention;

FIG. 13 is a flowchart of a packet removal (dequeue) in the buffer structure of FIG. 10 according to an embodiment of the present invention; and

FIG. 14 is a block diagram of a network device according to an embodiment of the present invention.

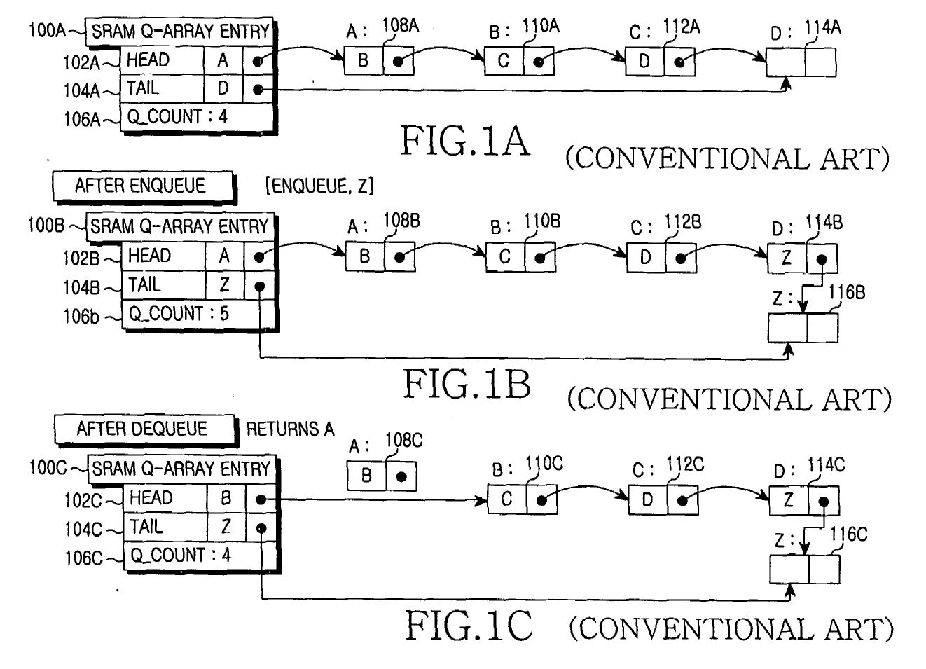

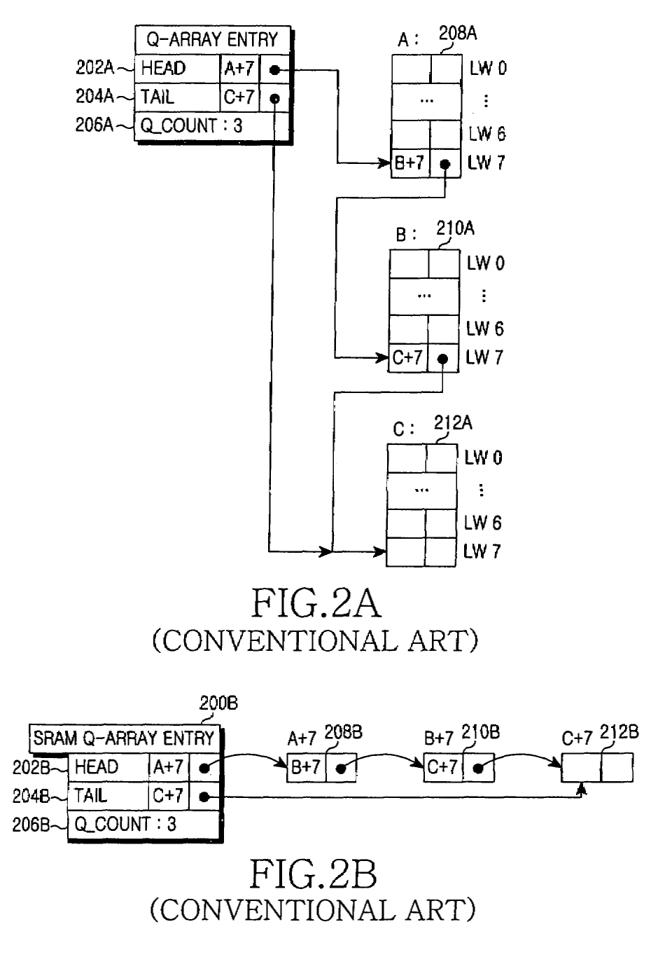

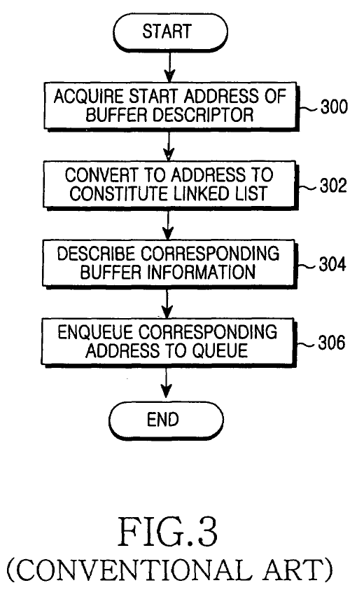

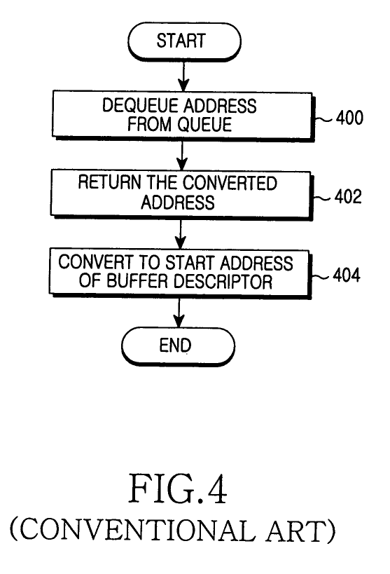

### DETAILED DESCRIPTION OF THE INVENTION

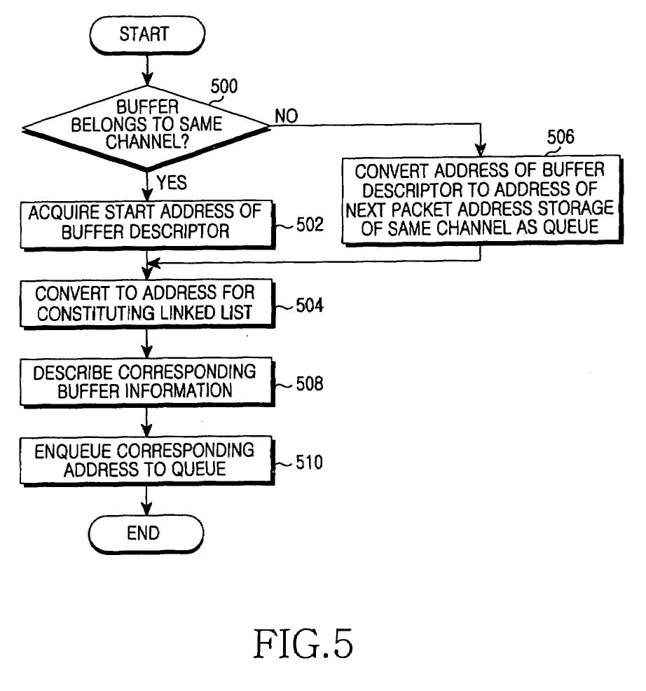

FIGS. 5 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged network system.

The present invention provides a method and an apparatus for processing buffers using different channels in one queue by allocating a storage area for buffer information to the different channel in a network system.

Hereinafter, it is assumed that a buffer structure for storing a queue meets the following conditions:

1. A storage area for storing an address of a next packet, besides an existing buffer descriptor, is allocated to a different channel.

2. The existing buffer descriptor address needs to be easily compatible with the storage area address of the different channels.

3. The usage of the storage address for storing the address of the next packet in the existing buffer descriptor (hereafter, referred to as a linked list address) and the usage of the storage address for storing the address of the next packet allocated to the different channel (hereafter, referred to as a linked list address of the next channel) should be distinguished simply based on their addresses. For example, while both of the address of the next packet address storage of the buffer descriptor in the channel 0 and the address of the next packet address storage which has the buffer descriptor in the channel 1 and the next packet address only allocated to the channel 0 are the channel 0 address, it should be possible to distinguish the channel addresses.

FIG. 5 is a flowchart of a packet insertion (enqueue) into a buffer according to an embodiment of the present invention.

In step 500, a network device checks whether a packet to be inserted belongs to the same memory channel. When the packet belongs to the same channel, the network device acquires a start address of a buffer descriptor of the packet in step 502. For example, when there is no transition from the channel processing the incoming packets to the channel processing the outgoing packets or when there is no transition from the channel processing the outgoing packets to the channel processing the incoming packets, the same channel is used.

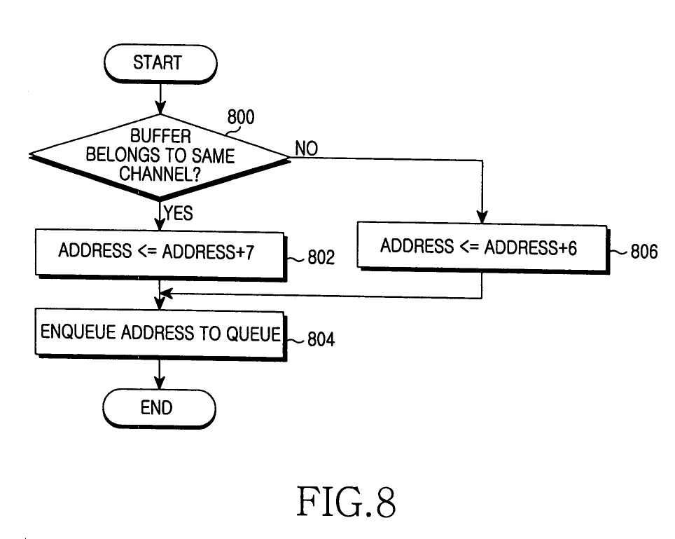

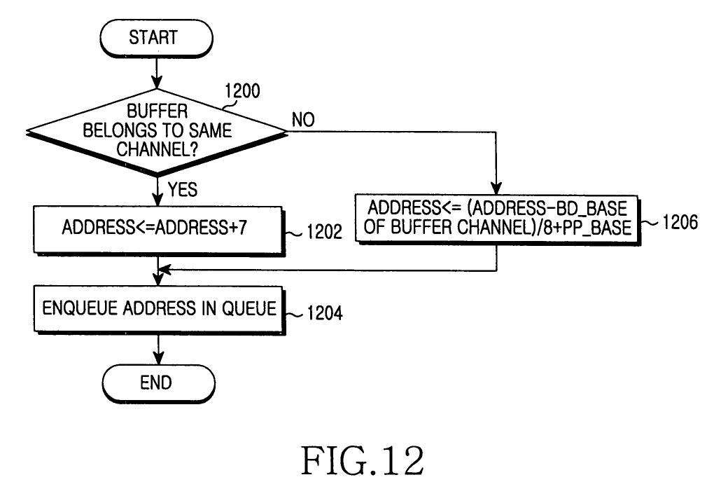

When the buffer does not belong to the same channel, the network device converts an address of a buffer descriptor to an address of the next packet address storage of the same channel as the queue in step 506. For example, when the incoming packet is sent out or when the outgoing packet is returned to an internal system, the address is converted to the address of the next packet address storage of the same channel as the queue because the used channels are different. An example of the address conversion will be described by referring to FIGS. 8 and 12.

In step 504, the network device converts the start address of the buffer descriptor to an address for constituting a linked list. An example of the address conversion will be explained by referring to FIGS. 8 and 12.

In step 508, the network device describes corresponding buffer information using the buffer descriptor.

In step 510, the network device enqueues the corresponding address to the queue. For instance, the network device changes the value in the tail of the queue descriptor to the converted linked list address and increases the Q_Count by one.

Next, the network device finishes this enqueue process.

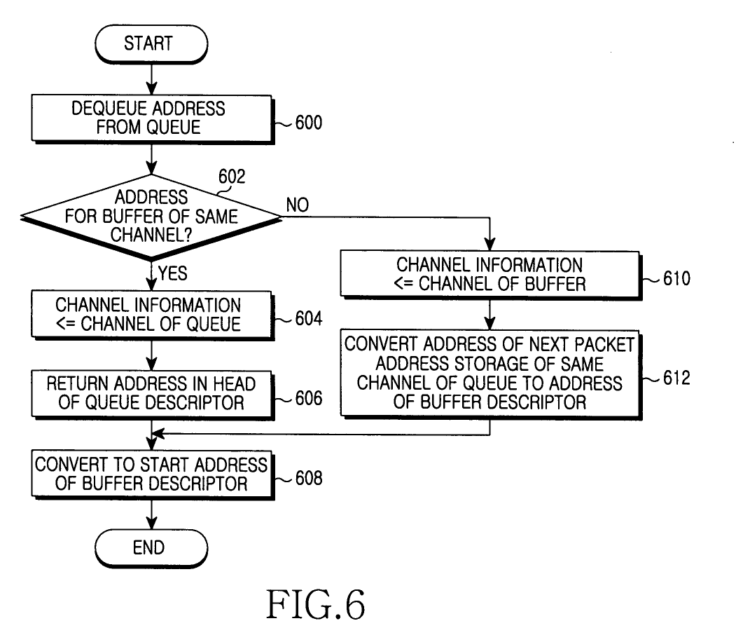

FIG. 6 is a flowchart of a packet removal (dequeue) from the buffer according to an embodiment of the present invention.

In step 600, the network device changes the address in the head of the queue descriptor to the address of the next packet address storage. Next, the network device decreases Q_Count by one.

In step 602, the network device checks whether the buffer of the packet to be removed belongs to the same memory channel. When the buffer belongs to the same channel, the network device uses channel information as the queue channel in step 604. This signifies that the original channel value of the buffer becomes the value of the current queue channel. For example, when the queue using the memory controller 0 is dequeued, the packet belongs to the original channel 0.

In step 606, the network device returns the linked list address in the head of the queue descriptor.

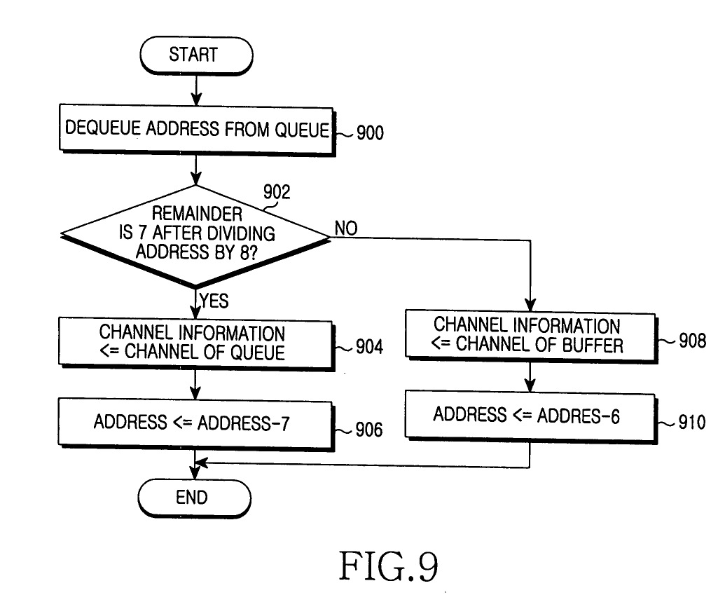

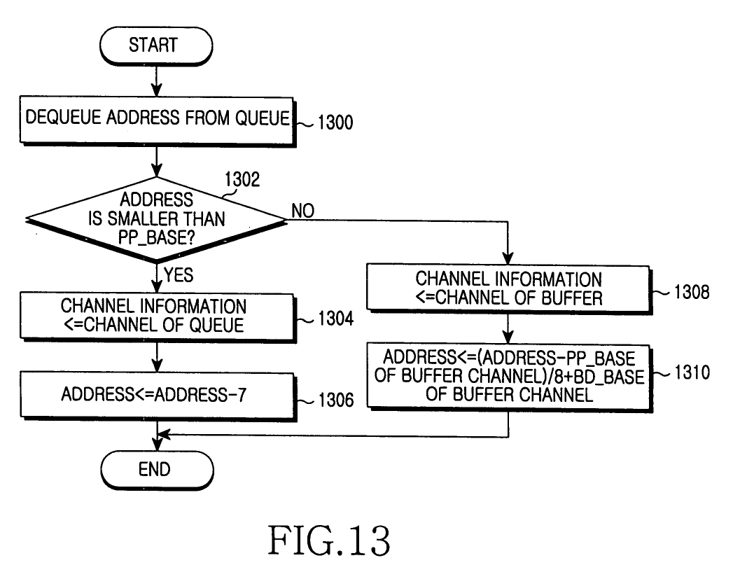

In step 608, the network device converts the linked list address to the start address of the buffer descriptor. An example of the address conversion will be explained by referring to FIGS. 9 and 13.

When the buffer belongs to a different channel, the network device uses channel information as the channel of the buffer in step 610. This signifies that the original channel is used for the packet processing.

In step 612, the network device converts the linked list address of the different channel to the start address of the buffer descriptor. An example of the address conversion will be explained by referring to FIGS. 9 and 13.

Next, the network device finishes the dequeue process.

Two examples of the buffer structure of FIGS. 5 and 6 are suggested. Table 2 shows a buffer structure used when the numbers of buffers in two channels are the same and the buffer descriptor has some space. For example, the existing software structure of Table 1 uses LW 7 of the buffer descriptor as the next packet address storage, whereas LW 6 in Table 2 is newly defined as the next packet address storage of the different channel.

TABLE 2

| | | Size | |
|---|---|---|---|
| LW | Bits | [bits] | Variable Name |
| 0 | 31:0 | 32 | next buffer address in the same packet |
| 1~5 | 31:0 | | omitted |
| 6 | 31:0 | 32 | next packet address used in the different |
| | | | channel buffer of the different channel and |
| | | | the same address |
| 7 | 31:0 | 32 | next packet address |

In Table 2, LW 0 is 32-bit (0˜31 bits) “next buffer address in the same packet” information, LW 6 is 32-bits (0˜31 bits) “next packet address used in the different channel buffer with the different channel and the same address (linked list address of the different channel)” information, and LW 7 is 32-bit (0˜31 bits) “next packet address” information. LW 1˜LW 5 are the same as in Table 1 and thus shall be omitted for brevity.

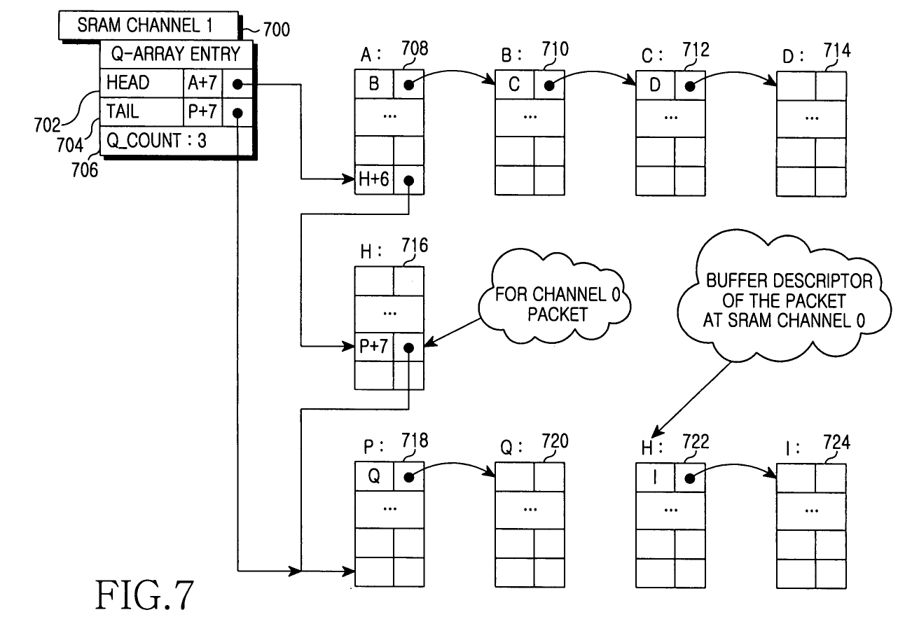

FIG. 7 is a diagram of a queue storage in the buffer structure of Table 2 according to an embodiment of the present invention.

A queue descriptor 700 describes the queue using a head 702 of A+7, a tail 704 of P+4, and Q_Count of 3. In detail, three packets are a linked list from the storage address A+7 of the first packet address to the storage address P+7 of the third packet address, to thus form a queue.

Buffer descriptors 708, 716 and 718 each include LW 0˜LW 7 information as defined in Table 2. The buffer descriptor 708 has the address A and contains the address H+6 of the next packet address storage in LW 7. The address H+6 denotes that the next packet is in the buffer using the different channel. The buffer descriptor 710 has the address P+7 of the next packet address storage in LW 6. The address H is present in both of the channel 0 and the channel 1, and the area H+6 of the channel 1 used in the queue of the channel 1 is actually for the buffer descriptor in H of the channel 0.

Buffer descriptors 708, 710, 712 and 714 each include “next buffer address in the same packet” as defined by the buffer descriptor of Table 2, and are the linked list. Buffer descriptors 718 and 720 each include “next buffer address in the same packet” as defined by the buffer descriptor of Table 2, and are the linked list. Buffer descriptors 722 and 724 are buffer descriptors of the packet in the memory channel 0.

FIG. 8 is a flowchart of a packet insertion (enqueue) in the buffer structure of Table 2 according to an embodiment of the present invention.

In step 800, the network device checks whether the buffer of the packet to be inserted and the different buffer to which the packet is inserted belong to the same memory channel. When the buffers belong to the same channel, the network device converts the address of the buffer descriptor to the linked list address in step 802. For example, when the buffer of the packet to be inserted to the current queue buffer uses the same channel as the channel of the queue buffer and the address of the packet to be inserted is X in FIG. 7, the linked list address is X+7 by adding 7 (LW) to the address (packet address) of the buffer descriptor. This is to distinguish the packets in the different channel buffer which has the different channel and the same address.

When the buffers do not belong to the same channel, the network device converts the address to the linked list address of the different channel in step 806. The conversion adds 6 (LW) to the address of the buffer descriptor. For example, when the buffer of the packet to be inserted to the current queue buffer uses the different channel from the channel of the queue buffer and the address of the inserted packet is X in FIG. 7, the linked list address is X+6 by adding 6 (LW) to the address (packet address) of the buffer descriptor. This is to distinguish the packets in the buffers of the different channels and the same address.

In step 804, the network device enqueues the address to the queue. For example, the network device changes the value in the tail of the queue descriptor to the linked list address and increases Q_Count by one. When the buffer of the packet to be inserted to the current queue buffer uses the same channel as the channel of the queue buffer in FIG. 7, the value in the tail 704 of the queue descriptor is changed to X+7 and the value in Q_Count 706 is changed to 4 by increasing by one. By contrast, when the buffer of the packet to be inserted to the current queue buffer uses the different channel from the channel of the queue buffer, the tail address value of the queue descriptor 700 is changed to X+6 and Q_Count 706 is changed to 4 by increasing by one.

Next, the network device finishes the enqueue process.

FIG. 9 is a flowchart of a packet removal (dequeue) in the buffer structure of Table 2 according to an embodiment of the present invention.

In step 900, the network device dequeues the address from the queue. The network device changes the address in the head and decreases Q_Count by one. For example, the network device changes the head 702 to H+6 and changes Q_Count 706 to 2 in the queue descriptor 700 of FIG. 7.

Next, when the address of the buffer descriptor is assigned as the multiple of 8, the network device checks whether the remainder after dividing the address of the buffer descriptor by 8 is 7 or not in step 902. When the remainder is 7, the network device uses channel information as the channel of the queue in step 904. This is to check whether the removed packet is in the same channel as the channel of the current queue buffer or not. The remainder 7 signifies that the removed packet is in the same channel as the channel of the current queue packet, and accordingly, the channel information is used as the channel of the current queue buffer.

In step 906, the network device converts the address by subtracting 7 from the address of the buffer descriptor. This address conversion converts the linked list address to the original address of the buffer descriptor. For example, in FIG. 7, the network device restores the original address A of the buffer descriptor by subtracting 7 from the address A+7 for the dequeue.

When the remainder is not 7, the network device uses the channel of the buffer as the channel information in step 908. When the remainder is not 7, the removed packet is in the channel different from the current queue buffer. Thus, the buffer channel of the removed packet is used as the channel information.

In step 910, the network device converts the address by subtracting 6 from the address of the buffer descriptor. For example, after one dequeue in FIG. 7, the value in the head is H+6. After one more dequeue, the remainder is not 7 any more. Hence, the address is converted to the original address H of the buffer descriptor by subtracting 6 from the address H+6.

Next, the network device finishes this dequeue process.

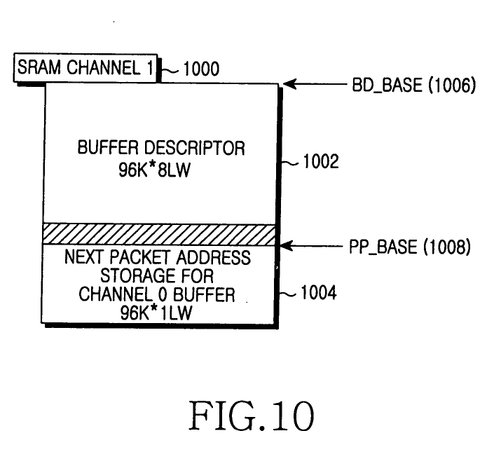

FIG. 10 depicts a buffer structure according to another embodiment of the present invention.

The buffer structure of FIG. 10 can be used when the numbers of buffers of the channels are different or when the existing buffer descriptor cannot allocate the area for the different channel. A memory area 1002 for the buffer descriptor is allocated as 96K*8 LW in size from BD_BASE 1006, and a next packet address storage area 1004 for the different channel buffer is allocated as 96K*1 LW in size from PP_BASE 1008.

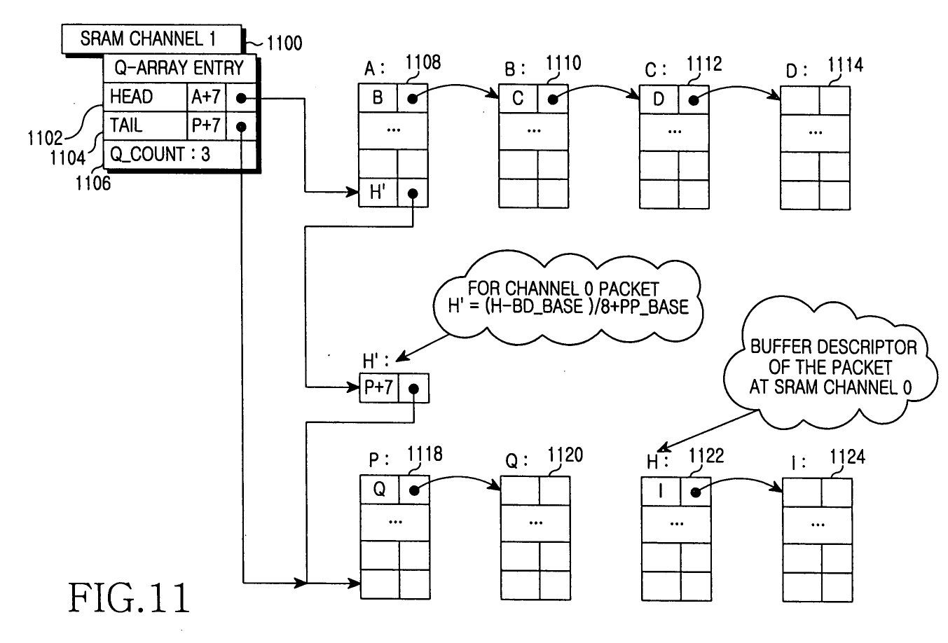

FIG. 11 is a diagram of a queue storage in the buffer structure of FIG. 10 according to an embodiment of the present invention.

A queue descriptor 1100 of FIG. 11 describes a queue using a head 1102 of A+7, a tail 1104 of P+7, and Q_Count of 3. Three packets are the linked list from the first packet storage address A+7 to the third packet storage address P+7 to form the queue. Buffer descriptors 1108, 1116 and 1118 include LW 0˜LW 7 information as the buffer descriptor of FIG. 10. The buffer descriptor 1108 has the address A, and the address H′ of the network packet address storage in LW 7. The address H′ denotes that the next packet is present in the buffer using a different channel.

Buffer descriptors 1108, 1110, 1112 and 1114 each include “next buffer address in the same packet” and are the linked list. Buffer descriptors 1118 and 1120 each include “next buffer address in the same packet” and are the linked list. Buffer descriptors 1122 and 1124 are the buffer descriptors of the packet in the memory channel 0.

FIG. 12 is a flowchart of a packet insertion (enqueue) in the buffer structure of FIG. 10 according to an embodiment of the present invention.

In step 1200, the network device checks whether the buffer of the packet to be inserted and the different buffer to which the packet is inserted belong to the same memory channel or not. When the two buffers belong to the same channel, the network device converts the address of the buffer descriptor to the linked list address in step 1202. For example, when the buffer of the packet to be inserted to the current queue buffer uses the channel same as the channel of the queue buffer and the address of the inserted packet of FIG. 11 is X, the linked list address is X+7 by adding 7 (LW) to the address (packet address) of the buffer descriptor. That is, the address of the inserted packet address storage is X+7.

When the two buffers do not belong to the same channel, the network device converts the address to the linked list address of the different channel in step 1106. For example, when the buffer of the packet to be inserted to the current queue buffer uses the different channel from the channel of the queue buffer and the address of the inserted packet of FIG. 11 is X, the linked list address is acquired based on Equation 1:

linked list address=(address of buffer descriptor−BD_BASE of buffer channel)/8+PP_BASE [Eqn. 1]

In Equation 1, BD_BASE of the buffer channel is the memory area start address of the buffer descriptor in the buffer structure of FIG. 10, and PP_BASE is the start address of the memory area allocated to distinguish the different buffer channel.

The packet used in the different channel buffer with the different channel and the same address is distinguished by moving to the memory area allocated for the next packet address storage for the different channel buffer.

In step 1204, the network device enqueues the address to the queue. For example, the network device changes the value in the tail of the queue descriptor to the linked list address and increases Q_Count by one. When the buffer of the packet to be inserted to the current queue buffer uses the same channel as the channel of the queue buffer in FIG. 11, the network devices changes the address value of the tail 1104 of the queue descriptor to X+7 and changes Q_Count 1106 to 4 by increasing by one. By contrast, when the buffer of the packet to be inserted to the current queue buffer uses the different channel from the channel of the queue buffer, the network devices changes the address value of the tail 1104 of the queue descriptor based on Equation (1) and changes Q_Count 1106 to 4 by increasing by one.

Next, the network device finishes this enqueue process.

FIG. 13 is a flowchart of a packet removal (dequeue) in the buffer structure of FIG. 10 according to an embodiment of the present invention.

In step 1300, the network device dequeues the address from the queue. The network device changes the address of the head and decreases Q_Count by one. For example, in FIG. 11, the network device changes the head 1102 to H′ and changes Q_Count 1106 to 2 in the queue descriptor 1100.

In step 1302, the network device determines whether the buffer address is smaller than PP_BASE. When the buffer address is smaller than PP_BASE, the network device uses the channel of the queue as the channel information in step 1304. This is to check whether the channel of the removed packet is the same as the channel of the current queue buffer or not. The current buffer address that is smaller than the PP_BASE signifies that the removed packet is in the same channel as the channel of the current queue buffer. Hence, the channel of the current queue buffer is used as the channel information.

In step 1306, the network device converts the address by subtracting 7 from the address of the buffer descriptor. The linked listed address is restored to the original address of the buffer descriptor. For example, in the dequeue of FIG. 11, the original address A of the buffer descriptor is acquired by subtracting 7 from the address A+7.

When the address is greater than the PP_BASE, the network device uses the channel of the buffer as the channel information in step 1308. Since the removed packet is in the channel different from the channel of the current queue buffer, the buffer channel of the removed packet is used as the channel information.

In step 1310, the network device converts the address of the buffer descriptor based on Equation 2:

linked list address=(address of buffer descriptor=PP_BASE)/8+BD_BASE of buffer channel [Eqn. 2]

In Equation 2, BD_BASE of the buffer channel is the memory area start address of the buffer descriptor in the buffer structure of FIG. 10, and PP_BASE is the start address of the memory area allocated to distinguish the different buffer channel.

For example, after one dequeue in FIG. 11, the head value is H′. After one more dequeue, H′ is greater than PP_BASE and converted to the original address H of the buffer descriptor based on Equation 2.

Next, the network device finishes this dequeue process.

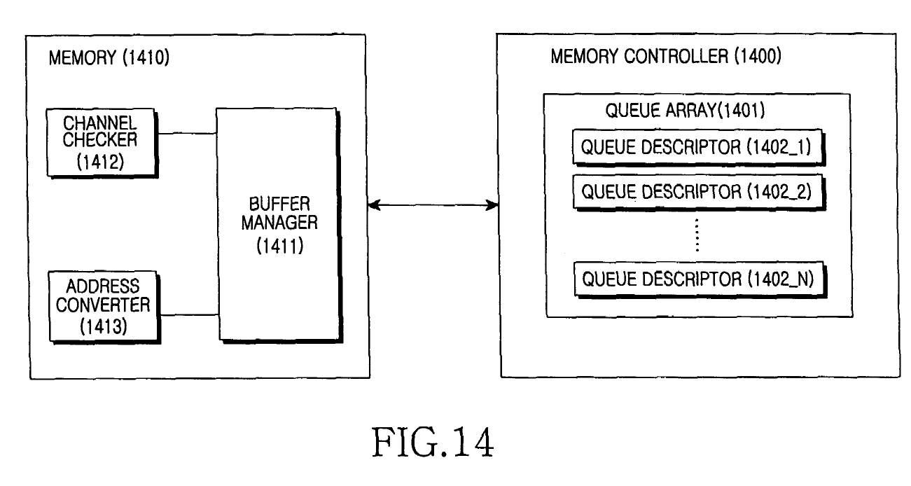

FIG. 14 is a block diagram of a network device according to an embodiment of the present invention.

The network device of FIG. 14 includes a memory controller 1400 and a memory 1410.

The memory controller 1400 includes a plurality of queue arrays. The queue array includes a plurality of queue descriptors. The memory 1410 includes a buffer manager 1411, a channel checker 1412, and an address converter 1413.

The buffer manager 1411 describes the buffer descriptor about the packet inserted to the buffer. For instance, the buffer manager 1411 records the buffer information of LW 0˜LW 7 using the buffer descriptors as defined in Table 1 or Table 2.

The channel checker 1412 checks whether the queue buffer uses the same memory channel. For example, in the buffer structure of Table 2, the channel checker 1412 divides the linked list address in the tail of the queue descriptor by 8, determines the same channel when the remainder is 7, and determines the different channel when the remainder is not 7. In the buffer structure of FIG. 10, the channel checker 1412 determines the same channel when address is smaller than the start address PP_BASE of the memory area for distinguish the different channel, and determines the different channel when the address is equal to or greater than the start address PP_BASE.

In the enqueue or the dequeue, the address converter 1413 converts the address (the buffer descriptor address) of the packet inserted or removed to the address of the packet address storage. Inversely, the address converter 1413 converts the address of the packet address storage to the address of the buffer descriptor. For example, in the buffer structure of Table 2, using the same channel, the address converter 1413 converts the address by adding 7 to the address of the buffer descriptor for the queue of the same channel and inversely converts the address by subtracting 7 from the address for the dequeue. Using the different channel, 6 is added to the buffer descriptor address in the enqueue and 6 is subtracted from the buffer descriptor address in the dequeue. In the buffer structure of FIG. 10, the address converter 1413 converts the address based on Equation 1. for the enqueue and converts the address based on Equation 2 for the dequeue.

As set forth above, by processing the buffers using the different channels in the same queue, the high-speed packet forwarding can be achieved. When the buffer capacity using one memory channel is deficient, multiple memory channels can be shared. Further, the influence on the existing software can be minimized.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A queue processing method in a network system, the method comprising:
when a packet is input to a buffer, checking whether the buffer belongs to a same memory channel;
when the buffer does not belong to the same memory channel, converting an address of a buffer descriptor about the packet to an address of a next packet address storage of the same memory channel of a queue; and
enqueuing the converted address.

2. The queue processing method of claim 1, wherein the step of enqueuing updates a tail item of a queue array with the converted address and increases a number of packets in the queue by one.

3. The queue processing method of claim 1, further comprising:
when the buffer belongs to the same memory channel, converting the address of the buffer descriptor about the packet to an address of a next packet address storage in the buffer descriptor.

4. The queue processing method of claim 1, wherein the buffer descriptor is defined as shown in the following table:

| | | Size | |
|---|---|---|---|
| LW | Bits | [bits] | Variable Name |
| 0 | 31:0 | 32 | next buffer address in the same packet |
| 1 | 31:16 | 16 | buffer_size |
| | 15:0 | 16 | offset |
| 2 | 31:16 | 16 | packet_size |
| | 15:12 | 4 | free_list_id |
| | 11:8 | 4 | rx_stat |
| | 7:0 | 8 | header_type |
| 3 | 31:16 | 16 | input_port |
| | 15:0 | 16 | output_port |
| 4 | 31:16 | 16 | next_hop_id |
| | 15:8 | 8 | fabric_port |
| | 7:4 | 4 | reserved |
| | 3:0 | 4 | nhid_type |
| 5 | 31:0 | 32 | flow_id |
| 6 | 31:0 | 32 | next packet address used in the different |
| | | | channel buffer of the different channel and |
| | | | the same address |
| 7 | 31:0 | 32 | next packet address |

wherein LW 0 is 32-bit (0˜31 bits) “next buffer address in the same packet” information, LW 6 is 32-bits (0˜31 bits) “next packet address used in the different channel buffer with the different channel and the same address (linked list address of the different channel)” information, and LW 7 is 32-bit (0˜31 bits) “next packet address” information.

5. The queue processing method of claim 1, wherein the step of converting the address of the buffer descriptor about the packet to the address of the next packet address storage of the same channel as the queue is determined by a memory address allocated to distinguish channels.

6. The queue processing method of claim 5, wherein the address of the next packet address storage of the same channel as the queue is acquired based on the following equation:
linked list address=(address of buffer descriptor−BD_BASE of buffer channel)/8+PP_BASE,
where BD_BASE of the buffer channel is a memory area start address of a buffer descriptor in a buffer structure, and PP_BASE is a start address of a memory area allocated to distinguish a different buffer channel.

7. The queue processing method of claim 1, wherein a buffer which satisfies the buffer descriptor is divided into a memory area for the buffer descriptor and a next packet address storage area for a different channel buffer.

8. A queue processing method in a network system, the method comprising:
when a packet is output from a buffer, checking whether the buffer belongs to a same memory channel;
when the buffer does not belong to the memory channel, converting an address of a next packet address storage of the same memory channel of a queue to an address of a buffer descriptor using channel information of the buffer; and
dequeuing the converted address.

9. The queue processing method of claim 8, wherein the step of dequeuing updates a head item of a queue array with the converted address and decreases a number of packets in a queue by one.

10. The queue processing method of claim 8, further comprising:
when the buffer belongs to the same memory channel, converting the address of a next packet address storage in the buffer descriptor to an address of a buffer descriptor using channel information of the queue.

11. The queue processing method of claim 8, wherein the buffer descriptor is defined as shown in the following table:

| | | Size | |
|---|---|---|---|
| LW | Bits | [bits] | Variable Name |
| 0 | 31:0 | 32 | next buffer address in the same packet |
| 1 | 31:16 | 16 | buffer_size |
| | 15:0 | 16 | offset |
| 2 | 31:16 | 16 | packet_size |
| | 15:12 | 4 | free_list_id |
| | 11:8 | 4 | rx_stat |
| | 7:0 | 8 | header_type |
| 3 | 31:16 | 16 | input_port |
| | 15:0 | 16 | output_port |
| 4 | 31:16 | 16 | next_hop_id |
| | 15:8 | 8 | fabric_port |
| | 7:4 | 4 | reserved |
| | 3:0 | 4 | nhid_type |
| 5 | 31:0 | 32 | flow_id |
| 6 | 31:0 | 32 | next packet address used in the different |
| | | | channel buffer of the different channel and |
| | | | the same address |
| 7 | 31:0 | 32 | next packet address |

where LW 0 is 32-bit (0˜31 bits) “next buffer address in the same packet” information, LW 6 is 32-bits (0˜31 bits) “next packet address used in the different channel buffer with the different channel and the same address (linked list address of the different channel)” information, and LW 7 is 32-bit (0˜31 bits) “next packet address” information.

12. The queue processing method of claim 8, wherein the step of converting the address of the next packet address storage of the same channel as the queue to the address of the buffer descriptor is determined by a memory address allocated to distinguish channels.

13. The queue processing method of claim 12, wherein the address of the buffer descriptor is calculated based on the following equation:
linked list address=(address of buffer descriptor−PP_BASE)/8+BD_BASE of buffer channel
where BD_BASE of the buffer channel is a memory area start address of a buffer descriptor in a buffer structure, and PP_BASE is a start address of the memory area allocated to distinguish a different buffer channel.

14. The queue processing method of claim 8, wherein a buffer which satisfies the buffer descriptor is divided into a memory area for the buffer descriptor and a next packet address storage area for a different channel buffer.

15. A queue processing apparatus in a network system, the apparatus comprising:
a channel checker for, when a packet is input to a buffer, checking whether the buffer belongs to a same memory channel;
an address converter for, when the buffer does not belong to the same memory channel, converting an address of a buffer descriptor about the packet to an address of a next packet address storage of the same memory channel of a queue; and
a buffer manager for enqueuing the converted address.

16. The queue processing apparatus of claim 15, wherein the buffer manager updates a tail item of a queue array with the converted address and increases a number of packets in the queue by one.

17. The queue processing apparatus of claim 15, wherein, when the buffer belongs to the same memory channel, the address converter converts the address of the buffer descriptor about the packet to an address of a next packet address storage in the buffer descriptor.

18. The queue processing apparatus of claim 15, wherein the buffer descriptor is defined as shown in the following table:

| | | Size | |
|---|---|---|---|
| LW | Bits | [bits] | Variable Name |
| 0 | 31:0 | 32 | next buffer address in the same packet |
| 1 | 31:16 | 16 | buffer_size |
| | 15:0 | 16 | offset |
| 2 | 31:16 | 16 | packet_size |
| | 15:12 | 4 | free_list_id |
| | 11:8 | 4 | rx_stat |
| | 7:0 | 8 | header_type |
| 3 | 31:16 | 16 | input_port |
| | 15:0 | 16 | output_port |
| 4 | 31:16 | 16 | next_hop_id |
| | 15:8 | 8 | fabric_port |
| | 7:4 | 4 | reserved |
| | 3:0 | 4 | nhid_type |
| 5 | 31:0 | 32 | flow_id |
| 6 | 31:0 | 32 | next packet address used in the different |
| | | | channel buffer of the different channel and |
| | | | the same address |
| 7 | 31:0 | 32 | next packet address |

where LW 0 is 32-bit (0˜31 bits) “next buffer address in the same packet” information, LW 6 is 32-bits (0˜31 bits) “next packet address used in the different channel buffer with the different channel and the same address (linked list address of the different channel)” information, and LW 7 is 32-bit (0˜31 bits) “next packet address” information.

19. The queue processing apparatus of claim 15, wherein a buffer which satisfies the buffer descriptor is divided into a memory area for the buffer descriptor and a next packet address storage area for a different channel buffer.

20. A queue processing apparatus in a network system, the apparatus comprising:
a channel checker for, when a packet is output from a buffer, checking whether the buffer belongs to a same memory channel;
an address converter for, when the buffer does not belong to the same memory channel, converting an address of a next packet address storage of the same memory channel of a queue to an address of a buffer descriptor using channel information of the buffer; and
a buffer manager for dequeuing the converted address.

21. The queue processing apparatus of claim 20, wherein the buffer manager updates a head item of a queue array with the converted address and decreases a number of packets in a queue by one.

22. The queue processing apparatus of claim 20, wherein, when the buffer belongs to the same memory channel, the address converter converts an address of a next packet address storage in a buffer descriptor to an address of a buffer descriptor using channel information of the queue.

23. The queue processing apparatus of claim 20, wherein the buffer descriptor is defined as shown in the following table:

| | | Size | |
|---|---|---|---|
| LW | Bits | [bits] | Variable Name |
| 0 | 31:0 | 32 | next buffer address in the same packet |
| 1 | 31:16 | 16 | buffer_size |
| | 15:0 | 16 | offset |
| 2 | 31:16 | 16 | packet_size |
| | 15:12 | 4 | free_list_id |
| | 11:8 | 4 | rx_stat |
| | 7:0 | 8 | header_type |
| 3 | 31:16 | 16 | input_port |
| | 15:0 | 16 | output_port |
| 4 | 31:16 | 16 | next_hop_id |
| | 15:8 | 8 | fabric_port |
| | 7:4 | 4 | reserved |
| | 3:0 | 4 | nhid_type |
| 5 | 31:0 | 32 | flow_id |
| 6 | 31:0 | 32 | next packet address used in the different |
| | | | channel buffer of the different channel and |
| | | | the same address |
| 7 | 31:0 | 32 | next packet address |

where LW 0 is 32-bit (0˜31 bits) “next buffer address in the same packet” information, LW 6 is 32-bits (0˜31 bits) “next packet address used in the different channel buffer with the different channel and the same address (linked list address of the different channel)” information, and LW 7 is 32-bit (0˜31 bits) “next packet address” information.

24. The queue processing apparatus of claim 20, wherein a buffer which satisfies the buffer descriptor is divided into a memory area for the buffer descriptor and a next packet address storage area for a different channel buffer.
